(19) United States
(12) Patent Application Publication
(10) Pub. No.: US 2008/0162866 A1
(43) Pub. Date: Jul. 3, 2008

(54) Apparatus and method for fast and secure memory context switching

(76) Inventors: Faraz A. Siddiqi, Portland, OR (US); Kirk Brannock, Hillsboro, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/648,455

(22) Filed: Dec. 28, 2006

(51) Int. Cl. G06F 12/06

(52) U.S. Cl. 711/173; 711/E12.084

(57) ABSTRACT

An apparatus comprising a memory controller including therein a configuration register, a communication channel coupled to the memory controller, and first and second memory partitions coupled to the communication channel, wherein configuration parameters in the configuration register are set so that the memory controller recognizes one partition at a time. A process comprising setting configuration parameters in a configuration register of a memory controller so that the memory controller recognizes a first memory partition coupled to the memory controller by a communication channel instead of a second memory partition coupled to the memory controller by the communication channel and re-setting the configuration parameters so that the memory controller recognizes the second memory partition instead of the first memory partition.

### TECHNICAL FIELD

The present invention relates generally to computer memory and in particular, but not exclusively, to an apparatus, system and method for fast and secure memory context switching in a computer memory.

### BACKGROUND

Most if not all computers operate using some sort of context. The most familiar and most used context is the operating system that runs all the basic functions of nearly every computer. The operating system is the “super program” that controls the basic operations of the computer such as input, output, scheduling and memory management and also provides the context within which other programs, such as user applications, can run. Thus, for example, most personal computers use some version of Microsoft Windows as an operating system, and MS Windows provides the context within which application such as Microsoft Outlook, Word and Excel can run.

In some circumstances a user might have some applications that run on MS Windows and others that run on a different operating system such as Linux, and it might occasionally be necessary to switch between Windows and Linux. In these circumstances, it would be most convenient and economical for the user to be able to use more than one operating system on the same computer instead of having a separate computer running each operating system. This can be accomplished by enabling the user to switch contexts by switching operating systems. FIG. 1 illustrates a current implementation of context-switching, described here in terms of switching between first and second operating systems. FIG. 1 schematically illustrates a basic memory system 100 including a memory controller 102, storage 104 and a memory 106. Both storage 104 and memory 106 are coupled to memory controller 102. At start-up of the computer of which system 100 is a part, memory controller 102 receives commands from a processor (not shown) that cause it to retrieve code for the first operating system from storage 104 and copy it into memory 106. Once loaded into memory 106, the computer runs the first operating system, as well as any programs that run on that operating system.

When the computer user wants to change operating systems, he or she can instruct system 100 to switch between the first operating system and the second operating system. In a very primitive and basic implementation, upon receiving the instruction to switch operating systems the entire computer shuts down and proceeds to re-boot using the second operating system. In a slightly more sophisticated implementation, when system 100 receives an instruction to switch operating systems the processor sends instructions to memory controller 102 to flush the first operating system from memory 106. Once the first operating system is flushed from memory, memory controller 102 accesses storage 104, where it finds the code for the second operating system and then transfers the code from storage 104 to memory 106. Once the second operating system is loaded in memory 106, system 100 runs using the second operating system and can use applications designed for the second operating system.

The context-switching approaches described above in connection with FIG. 1 have several disadvantages, most notable of which is how long and burdensome it is to switch between operating systems. Access to and reading from storage 104, which usually is a magnetic or optical disk drive, is slow and therefore it takes a while to load and start the second operating system. Another substantial disadvantage is that, in some cases, the computer must be physically shut down to accomplish the operating system switch; in other words, the user must physically power down the computer.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a current memory implementation of a multiple-operating system environment.

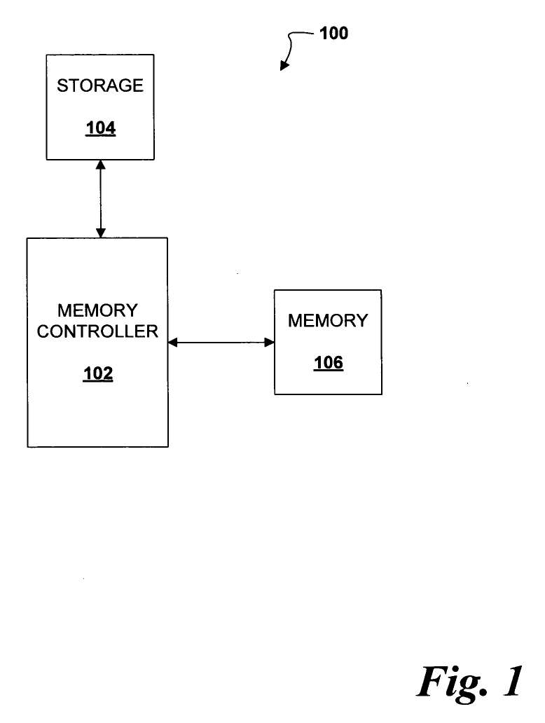

FIG. 2 is a block diagram of an embodiment of a partitioned memory context-switching system.

FIG. 3 is a block diagram of an alternative embodiment of a partitioned memory context-switching system.

FIG. 4 is a block diagram of an embodiment of a computer system including an embodiment of a partitioned memory context-switching system.

FIG. 5A is a flow chart illustrating an embodiment of the operation of a partitioned memory context-switching system such as the ones shown in FIG. 2 or 3.

FIG. 5B is a flow chart illustrating an alternative embodiment of the operation of a partitioned memory context-switching system such as the ones shown in FIG. 2 or 3.

FIG. 6A is a block diagram illustrating an embodiment of a memory configuration register for partitioning a memory.

FIG. 6B is a block diagram illustrating an alternative embodiment of a memory configuration register for partitioning a memory.

### DETAILED DESCRIPTION OF THE ILLUSTRATED EMBODIMENTS

Embodiments of an apparatus, system and method for fast and secure memory context switching are described herein. In the following description, numerous specific details are described to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail but are nonetheless encompassed within the scope of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

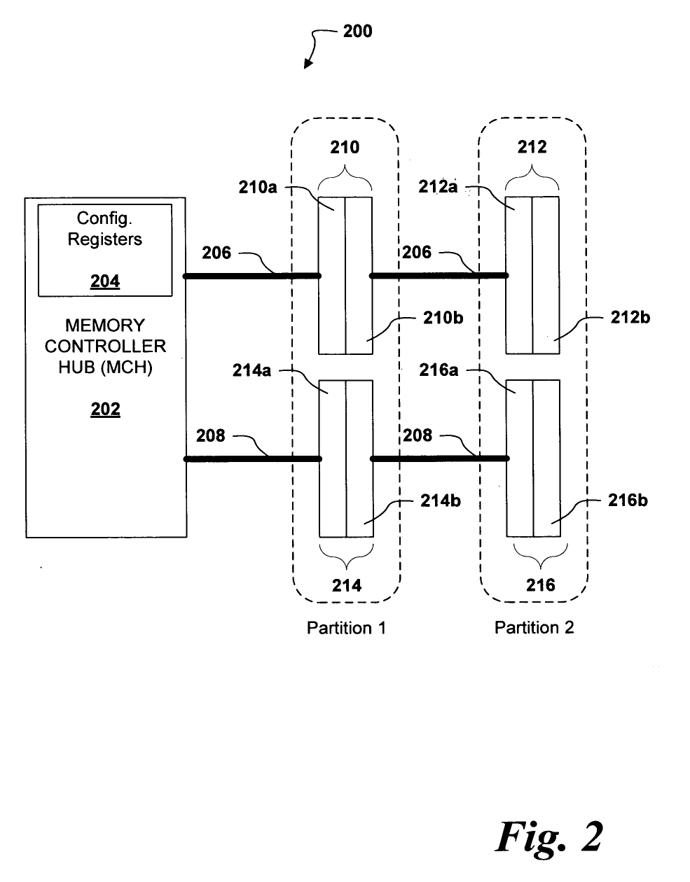

FIG. 2 illustrates an embodiment of a fast context-switching memory system 200. Memory system 200 includes a memory controller 202 having therein one or more configuration registers 204. At least one communication channel couples memory controller 202 to at least one memory—in this embodiment, a pair of communication channels 206 and 208 are each coupled to at least one memory: communication channel 206 is coupled to memory modules 210 and 212, whilst communication channel 208 is similarly coupled to memory modules 214 and 216. Other embodiments can, of course, include more or less communication channels, and each communication channel can be coupled to a greater or lesser number of memory modules than in the embodiment shown in the figure.

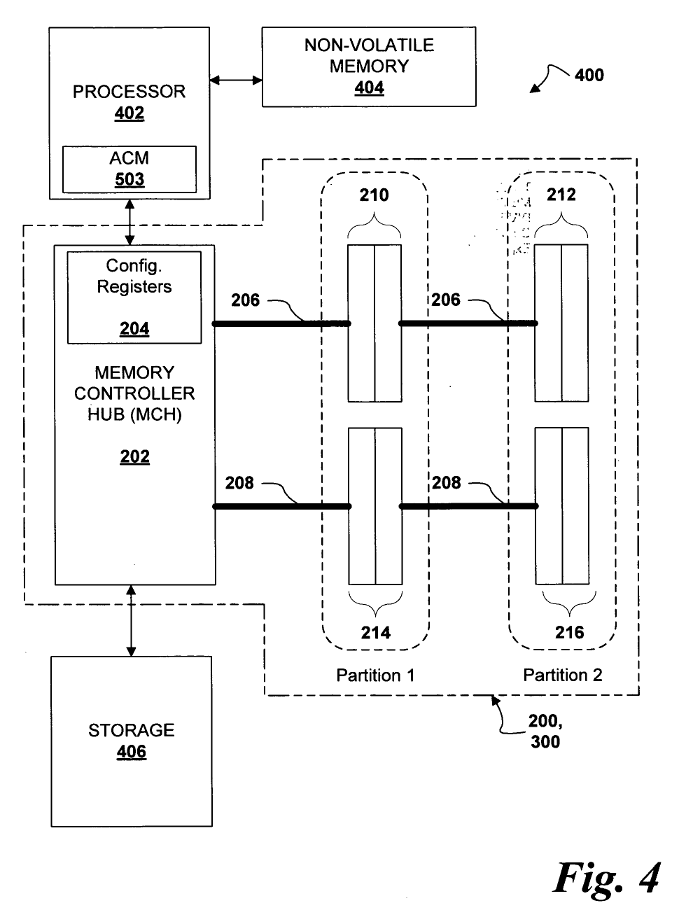

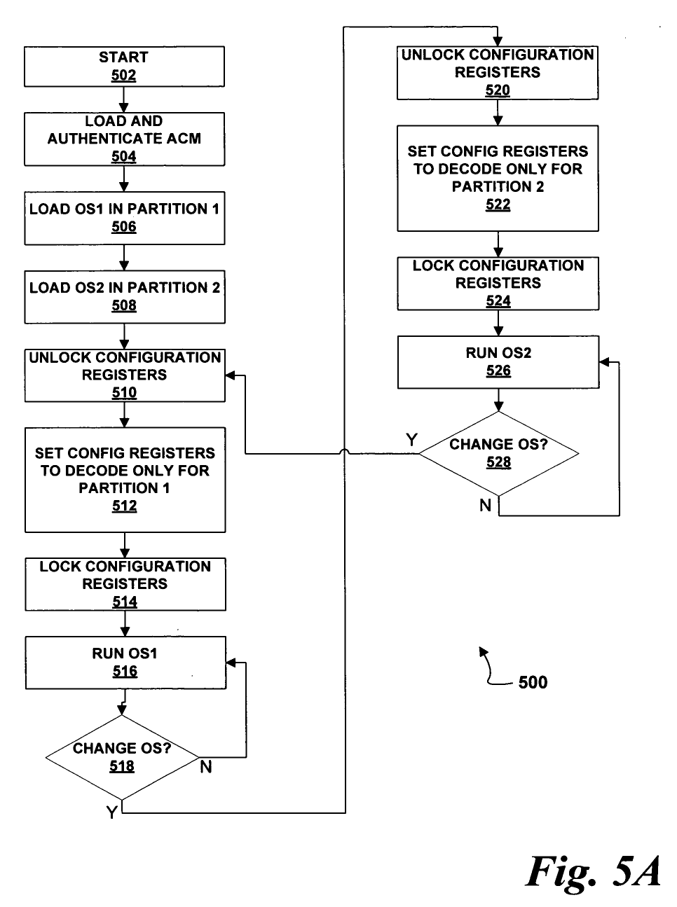

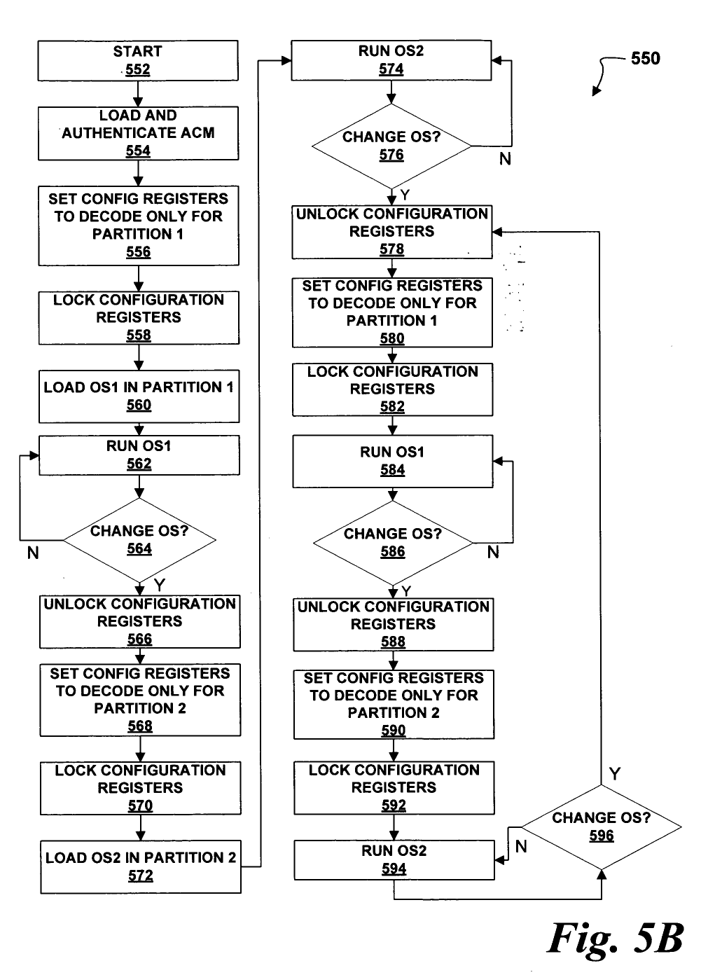

In the embodiment shown, memory modules 210, 212, 214 and 216 are Dual In-Line Memory Modules (DIMMs), each of which includes two rows of memory devices commonly known as “ranks.” Memory module 210, for example, consists of a first row or rank 210a and a second row or rank 210b. A memory device used in the modules can, in one embodiment, comprise a DRAM, although embodiments of the invention are not limited in this respect. Although the illustrated embodiment uses DIMM configurations for memory, in other embodiments of memory system 200 other kinds of memory modules, such as Single In-Line Memory Modules (SIMMs) and the like can be used. Moreover, all the memory modules in memory system 200 need not be of the same kind: in other embodiments any combination of different memory modules can be used for memory modules 210, 212, 214 and 216, so long as the memory modules used have sufficient capacity and can be appropriately addressed and configured using configuration register 204 on memory controller 202. Memory modules 210-216 are grouped into two memory partitions: a first memory partition including memory modules 210 and 214, and a second memory partition including memory modules 212 and 216. This memory partitioning is accomplished by setting appropriate parameters in the configuration register 204 so that the controller address decodes for one memory partition at a time, as further described below in connection with FIGS. 4 and 5. Configuring the registers this way ensures that the context (e.g., operating system) running in the first partition does not have access to memory in the second partition and the context (e.g., operating system) running in the second partition does not have access to memory in the first partition, thus avoiding problems such as memory access conflicts.

Communication channels 206 and 208 couple memory modules 210, 212, 214 and 216 to memory controller 202 and allow communication and data interchange between the memory modules and the controller. In one embodiment of memory system 200, communication channels 206 and 208 are electrically conductive paths capable of carrying electrical signals; memory buses in a printed circuit board are an example of such a conductive path. In other embodiments, however, the communication channels could be some other type of electrical communication channel, or could be an entirely different type of communication channel, for example an optical communication channel, such as a waveguide or an optical fiber.

Memory controller 202, also known as a Memory Controller Hub (MCH), controls the flow of data between and among memory modules 210, 212, 214 and 216, as well as the flow of data between memory controller 202 and other components found within a computer (not shown), such as a processor and/or a storage medium. Among other things, memory controller 212 includes at least one configuration register 204. In the illustrated embodiment, which uses DIMMs for memory modules, the configuration register 204 comprises DRAM Rank/Row Boundary (DRB) registers. DRB registers are used to map central processing unit (CPU) and direct memory access (DMA) addresses to the physical memory cells in memory modules 210-216.

On a typical computer system, the basic input-output system (BIOS) programs the configuration registers as part of its normal memory initialization sequence. BIOS queries the DIMMs to determine how much memory each DIMM supports and then programs the correct value in the DRB register for each DIMM. The parameters in the DRB registers tell the chipset how much memory each DIMM supports and how to map processor addresses to the physical memory cells on the DIMM. The DRB registers are programmed in an incremental manner. For a dual-channel embodiment such as the one illustrated:

Total Memory in Ch0=C0_{—}DRB0+C0_{—}DRB1+C0_{—}DRB2+C0_{—}DRB3

Total Memory in Ch1=C1_{—}DRB0+C1_{—}DRB1+C1_{—}DRB2+C1_{—}DRB3

Total Memory in a system=Total Memory in Ch0+Total Memory in Ch1

Many memory systems support dual memory channels, and therefore in such systems a separate set of DRB memory registers can be assigned for each memory channel. Such a dual-channel topology creates memory partitions in a way that does not impact system memory bandwidth.

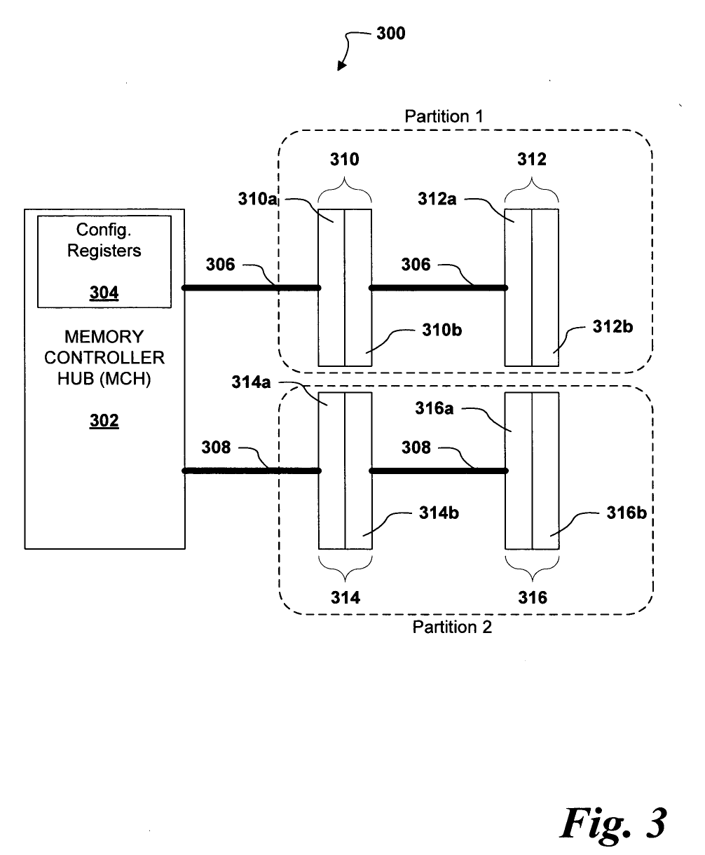

FIG. 3 illustrates an alternative embodiment of a context-switching memory system 300. As with memory system 200 shown in FIG. 2, memory 300 includes a memory controller 302 having therein one or more configuration registers 304. Also coupled to the memory controller 302 is a pair of communication channels 306 and 308. In addition to being coupled to memory controller 302, communication channel 306 is coupled to memory modules 310 and 312; similarly, communication channel 308 is coupled to memory modules 314 and 316.

Memory system 300 differs from memory system 200 mostly in the topology of the memory partitions. In memory system 200, each partition includes a memory module coupled to each communication channel; for example, the first partition includes memory module 210 coupled to communication channel 206 and memory module 214 coupled to communication channel 208. As a result, each memory partition in memory system 200 has two channels of communication with memory controller 202. By contrast, in memory system 300 each partition includes multiple memory modules coupled to the same communication channel; thus, in memory system 300 the first partition includes memory modules 310 and 312, both of which are coupled to the same communication channel 306, and the second partition includes memory modules 314 and 316, both of which are coupled to the same communication channel 308. As a result, each memory partition has one channel of communication with memory controller 302. As with memory system 200, in memory system 300 the partitions are created by adjusting parameter values within configuration registers 304 so that memory controller address decodes for one partition at a time. Configuring the registers this way ensures that the context (e.g., operating system) running in the first partition does not have access to memory in the second partition and the context (e.g., operating system) running in the second partition does not have access to memory in the first partition, thus avoiding problems such as memory access conflicts.

FIG. 4 illustrates an embodiment of a basic computer system 400 including a context-switching memory system such as memory systems 200 or 300. Computer system 400 includes a processor 402 that is coupled to a non-volatile memory 404 and to a memory controller 202 that forms part of a partitioned memory such as memory systems 200 or 300. Memory controller 202 is also coupled to a storage device 406.

Processor 402 can be any kind of processor, from a programmable general-purpose processor such as an Intel Pentium processor to an Application Specific Integrated Circuit (ASIC). Among other things, processor 402 includes a certain amount of on-board memory, such as Random-Access Memory (RAM) or other kind of memory, all or portions of which it can use to run certain programs.

One of the programs that processor 402 can run in its on-board memory is a privileged code module (i.e., a code module having greater memory access privileges than an operating system); in the embodiment shown, the privileged code module is an Authenticated Code Module (ACM) 403, but in other embodiments the privileged code module could be a System Management Mode (SMM) module, an embedded microcontroller, or some other privileged code module. In one embodiment the privileged code module is the sole means of at least un-locking the configuration registers, although in other embodiments the privileged code module can configure and lock the registers in addition to unlocking them. In still other embodiments, the privileged code module can un-lock the module while configuration and locking can be performed by a non-privileged code module. Allowing a privileged code module such as an ACM to at least unlock registers can be desirable because it ensures that at least un-locking of the registers is done by privileged code designed to work with the platform.

In the embodiment shown, ACM 403 is digitally signed and cryptographically bound to the platform. Binding is accomplished by computing the hash of the ACM public key and comparing it to a hash that is resident in the chipset or processor hardware. The ACM is launched using existing Secure Machine Extension (SMX) capabilities of the processor. Upon launch of the ACM, processor 402 loads the module into special memory (known as Authenticated Code RAM, or ACRAM) for verification and execution. In one embodiment, ACRAM can be implemented using a special mode of the processor cache, although in other embodiments it can be implemented differently, such as by using a portion of the on-board RAM. Other implementations of ACRAM are possible.

Once the ACM is loaded in ACRAM, the processor verifies the digital signature-to-platform binding, and then verifies the module itself using the digital signature. If the digital signature is successfully verified, processor 402 begins execution of the ACM in a privileged environment in which the ACM has access to privileged LT.Config.Lock and LT.Config.Un-lock commands in the controller. The controller honors these commands when they are issued by an ACM. The Lock/Un-Lock commands control locking and unlocking of the controller's memory control/configuration registers. Embodiments of the invention can use these special commands to unlock the memory configuration registers, change the memory configuration to create memory partitions, and re-lock the configuration registers to insure that memory partitioning can be enabled/disabled by the signed ACM.

Using these commands and/or others ACM 403 implements a secure switch that turns a memory partition on or off to allow switching between different OS contexts in the memory. This is done by manipulating memory configuration registers in a manner that enables hiding or revealing memory partitions and/or memory modules within a partition. In one embodiment, this memory manipulation involves setting the registers so that they address decode for one partition at a time, which allows the controller to manage multiple overlapping physical memory ranges such that one is visible at a time. In this way, the ACM can effectively partition the physical memory into two or more isolated ranges leveraging the controller decode logic to enforce the isolation. This allows for a quicker switching of OS context and adds security to the switching mechanism.

Processor 402 is coupled to non-volatile memory 404 which can be any kind of non-volatile memory; examples include flash memory, ROM, EPROM and the like. Among other things, non-volatile memory 404 can store the Basic Input-Output System (BIOS) that processor 402 needs operate its basic functions until an operating system can be loaded to take over operation of the computer. The BIOS boots the computer, establishes basic connections, performs certain functions prior to loading an operating system and loads the operating system.

FIG. 5A illustrates an embodiment of a process 500 by which a context-switching memory system such as system 200 or system 300 operates in computer system 400. Starting at block 502, the computer system starts up. At block 504 the system, for example by using its BIOS, loads an Authenticated Code Module (ACM) and authenticates the ACM. After the ACM is authenticated, at block 506 the system loads the first context—in this embodiment, the first operating system—into the first memory partition. At block 508, the system loads the second context—in this embodiment, the second operating system—into the second memory partition. After the operating systems are loaded into their respective partitions and booted, the configuration registers are unlocked at block 510 and parameters in the configuration registers are set so that address decoding occurs for the first partition. With configuration parameters set this way, the system recognizes the first partition and behaves as if the second partition is not there at all. Once the parameters in the configuration registers are properly set, the configuration registers are locked by the ACM at block 514. With address decoding for the first memory partition, at block 516 the system runs using the first operating system.

While running the first operating system, at block 518 the computer system checks whether an indication has been received to switch operating systems. If no indication is received, the system continues to run the first operating system at block 516. If an indication to switch operating systems is received at block 518, then the ACM unlocks the configuration registers at block 520 and at block 522 sets the parameters in the configuration register so that the controller now decodes addresses associated with the second partition; with configuration parameters set this way, the memory controller recognizes the second partition and behaves as if the first partition is not there at all. When the parameters in the configuration registers are set, the configuration registers are locked by the ACM at block 524 and the second operating system begins to run at block 526.

While running the second operating system, at block 528 the computer system checks whether an indication has been received to switch operating systems. If no indication is received, the system continues to run the second operating system at block 526. If an indication to switch operating systems is received at block 528, then the process returns to block 510, where the ACM unlocks the configuration registers at block 510 and at block 512 sets the parameters in the configuration register so that the controller again decodes addresses for the first partition. Once the parameters in the configuration registers are set, the configuration registers are locked by the ACM at block 514 and the first operating system begins to run at block 516.

FIG. 5B illustrates an alternative embodiment of a process 550 by which a context-switching memory system such as system 200 or system 300 operates in computer system 400. Process 550 differs from process 500 primarily in the sequence of loading the operating systems. In process 500, both operating systems are loaded at the beginning, and switching operating systems involves toggling between the two. In process 550, the first operating system is loaded and used to begin with and the second operating is loaded, booted and operated when it is needed. Once the second operating system is loaded, however, both are in memory and switching operating systems involves toggling between the two as in process 500.

Starting at block 552, the computer system starts up. At block 554 the system, for example by using its basic input-output system (BIOS), loads an Authenticated Code Module (ACM) and authenticates the ACM. After the ACM is authenticated, at block 556 the ACM sets the configuration registers to address decode for the first partition; with configuration parameters set this way, the system recognizes the first partition and behaves as if the second partition is not there at all. After the ACM locks the configuration registers at block 558, at block 560 the system loads the first context—in this embodiment, the first operating system—into the first memory partition, boots the operating system and runs the first operating system at block 562.

At block 564 the system awaits an indication to change contexts (i.e., operating systems). If no indication is received, the system continues to run the first operating system. If an indication to change operating systems is received at block 564, the ACM unlocks the configuration registers at block 566, sets the configuration registers to address decode for the second partition at block 568, and again locks the configuration registers at block 570. After locking the configuration registers, the system loads the second operating system into the second partition at block 572, boots the second operating system, and runs the second operating system at block 574.

At block 576 the system awaits an indication to change operating systems. If no indication is received, the system continues to run the second operating system. If an indication to change operating systems is received at block 576, the ACM unlocks the configuration registers at block 578, sets the configuration registers to address decode for the second partition at block 580, and again locks the configuration registers at block 582. After locking the configuration registers, the system switches over to the first operating system, which is already loaded into the first partition, and runs the first operating system at block 584.

At block 586 the system awaits an indication to change operating systems. If no indication is received, the system continues to run the first operating system at block 584. If an indication to change operating systems is received at block 586, the ACM unlocks the configuration registers at block 588, sets the configuration registers to address decode for the second partition at block 590, and again locks the configuration registers at block 592. After locking the configuration registers, the system switches over to the second operating system, which is already loaded into the second partition, and runs the second operating system at block 594.

At block 596 the system awaits an indication to change operating systems. If no indication is received, the system continues to run the second operating system at block 594. If an indication to change operating systems is received at block 596, the process returns to block 578, where it again goes through the context-switching sequence and runs the first operating system at block 584.

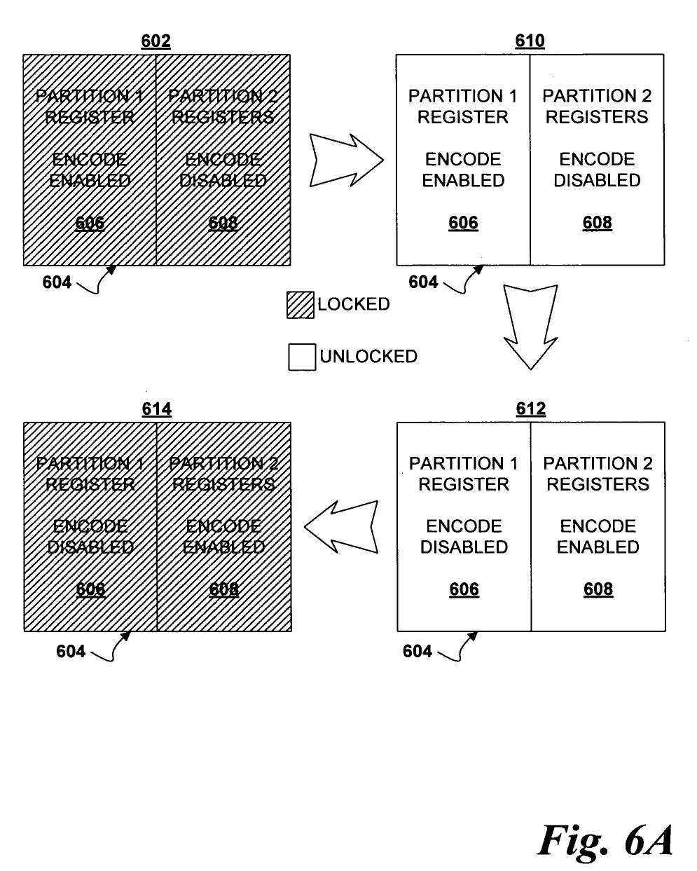

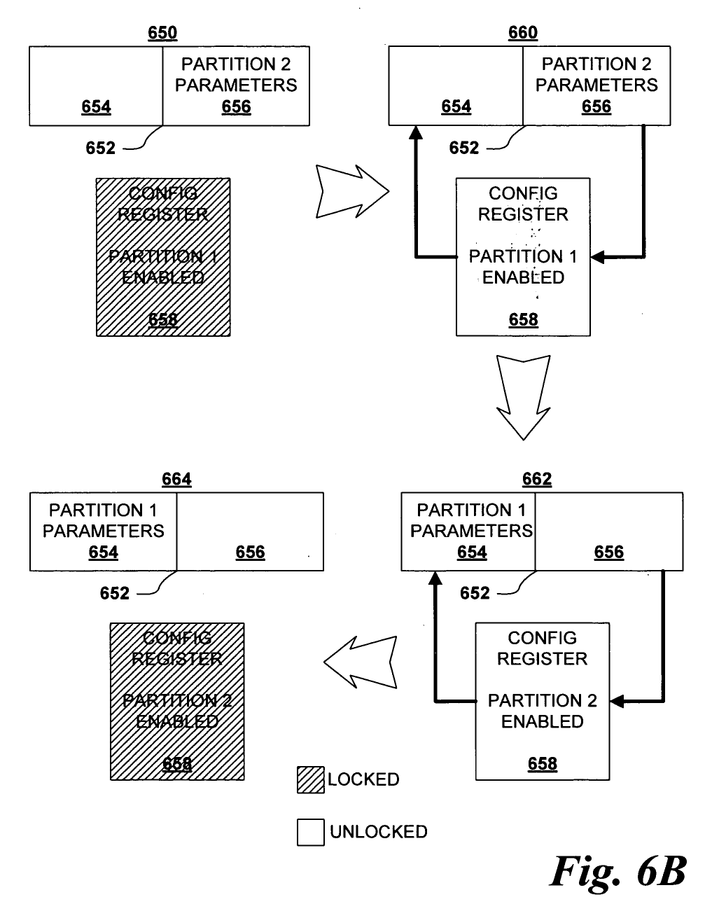

FIG. 6A illustrates an embodiment of a configuration register 604 that can be used to configure and partition the memory in a context-switching memory system such as system 200 or system 300. Operation of configuration register 604 will be discussed with reference to process 500 shown in FIG. 5A; extension of the operation of configuration register to process 550 shown in FIG. 5B is similar, the primary difference being in the sequence of locking, unlocking and configuring the configuration registers. Configuration register 604 includes two parts: a first part 606 that stores the parameters for the first memory partition and a second part 608 that stores the parameters for the second partition. In an initial state 602 configuration register 604 is locked and parameters in part 606 are set to address decode for the first memory partition, while parameter parameters in part 608 are set to not address decode for the second memory partition. In the embodiment of operation shown in FIG. 4, configuration register state 602 corresponds to blocks 514 and 516.

When memory controller 202 or 302 receives an indication to change contexts at block 518—in this embodiment, by changing operating systems—configuration register 604 transitions from state 602 to state 610, where it has been unlocked by the Authenticated Code Module (ACM); state 610 therefore corresponds to block 520. After configuration register 604 is unlocked it transitions from state 610 to state 612, in which the parameters for the first memory partition are set so that there is no address encoding for that portion and the parameters for the second memory partition are set so that there is decoding for that partition. The setup of configuration register 604 at state 612 essentially transposes the setup at state 602 and corresponds to block 522. Finally, at state 614 configuration register 604 is again locked in the configuration of state 612; state 614 therefore corresponds to blocks 524 and 526. To switch context from the second operating system back to the first, the configuration registers 604 is re-configured substantially in the reverse order. In other words, the configuration registers start at state 614 (corresponding to blocks 524 and 526) and transition to state 612 (corresponding to block 510), then to state 610 (corresponding to block 512) and finally to state 602, which corresponds to blocks 514 and 516.

FIG. 6B illustrates an alternative embodiment of a configuration register 658 that can be used to configure and partition the memory in a partitioned memory system such as system 200 or system 300. In contrast to configuration register 604, configuration register 658 includes one part that stores parameters for one memory partition at a time. To allow context switching, configuration register 658 can be coupled to a separate memory 652 that allocates a first part 564 to store parameters for the first memory partition and a second part 656 to store parameters for the second memory partition.

As with configuration register 604, operation of configuration register 658 will be discussed with reference to process 500 shown in FIG. 5A. In an initial state 650, configuration register 658 is locked and parameters in the register are set to address decode for the first memory partition. Parameters for the second partition are stored in part 656 of memory 652. In the operational embodiment shown in FIG. 5A, configuration register state 650 corresponds to block 514.

When memory controller 202 or 302 receives an indication to change contexts at block 518—in this example, by changing operating systems—configuration register 658 transitions from state 650 to state 660, where it has been unlocked by an Authenticated Code Module (ACM); state 610 therefore corresponds to block 520. After configuration register 658 is unlocked it transitions from state 650 to state 660, in which data communication is established between configuration register 658 and memory 652. Once data communication is established, the parameters for the first memory partition are copied from configuration register 658 to part 654 of memory 652, while parameters for the second memory partition are copied from part 656 of memory 652 to configuration register 658. At state 662, parameters for the second memory partition are loaded into configuration register 658, and the setup of configuration register 658 at state 662 corresponds to block 522. Finally, at state 664 configuration register 604 is locked in the configuration of state 662; state 664 therefore corresponds to block 524.

To switch context from the second operating system back to the first, the configuration registers 658 is re-configured substantially in the reverse order. In other words, the configuration registers start at state 664 (corresponding to blocks 524 and 526) and transition to state 662 (corresponding to block 510), then to state 660 (corresponding to block 512) and finally to state 650, which corresponds to blocks 514 and 516.

The above description of illustrated embodiments of the invention, including what is described in the abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. An apparatus comprising:
a memory controller including therein a configuration register;
a communication channel coupled to the memory controller; and
first and second memory partitions coupled to the communication channel, wherein configuration parameters in the configuration register are set so that the memory controller recognizes one partition at a time.

2. The apparatus of claim 1 wherein the communication channel comprises first and second communication channels and wherein the first memory partition is coupled to the first communication channel and the second memory partition is coupled to the second communication channel.

3. The apparatus of claim 1 wherein the communication channel comprises first and second communication channels and wherein each of the first memory partition and the second memory partition are coupled to both the first communication channel and the second communication channel.

4. The apparatus of claim 1 wherein each memory partition includes at least one memory.

5. The apparatus of claim 1 wherein the parameters in the configuration register are set so that the memory controller address decodes for one memory partition at a time.

6. The apparatus of claim 1 wherein the configuration register comprises a first configuration register and a second configuration register, each register having therein configuration parameters for a corresponding memory partition, wherein one register at a time is set to address decode for its corresponding memory partition.

7. The apparatus of claim 1, further comprising one or more additional memory partitions.

8. The apparatus of claim 1 wherein the configuration register can be locked and unlocked.

9. The apparatus of claim 8 wherein at least the unlocking is done by a privileged code module having greater memory access privilege than an operating system.

10. The apparatus of claim 9 wherein the privileged code module is the sole means of unlocking the configuration register.

11. The apparatus of claim 9 wherein the privileged code module is an Authenticated Code Module (ACM), a System Management Mode (SMM) module, or an embedded microcontroller.

12. A system comprising:
a processor;
a storage device coupled to the processor; and
a memory system coupled to the processor, the memory system comprising:
a memory controller including therein a configuration register;
a communication channel coupled to the memory controller; and
first and second memory partitions coupled to the communication channel, wherein configuration parameters in the configuration register are set so that the memory controller recognizes one partition at a time.

13. The system of claim 12 wherein the communication channel comprises first and second communication channels and wherein the first memory partition is coupled to the first communication channel and the second memory partition is coupled to the second communication channel.

14. The system of claim 12 wherein the communication channel comprises first and second communication channels and wherein each of the first memory partition and the second memory partition are coupled to both the first communication channel and the second communication channel.

15. The system of claim 12 wherein the parameters in the configuration register are set so that the memory controller address decodes for one memory partition at a time.

16. The system of claim 12 wherein the configuration register comprises a first configuration register and a second configuration register, each register corresponding to one of the memory partitions.

17. The system of claim 12, further comprising one or more additional memory partitions.

18. The system of claim 12 wherein the configuration register can be locked and unlocked.

19. The system of claim 18 wherein at least the unlocking is done by a privileged code module having greater memory access privilege than an operating system.

20. The system of claim 19 wherein the privileged code module is the sole means of unlocking the configuration register.

21. The system of claim 19 wherein the privileged code module is an Authenticated Code Module (ACM), a System Management Mode (SMM) module, or an embedded microcontroller.

22. A process comprising:
setting configuration parameters in a configuration register of a memory controller so that the memory controller recognizes a first memory partition coupled to the memory controller by a communication channel instead of a second memory partition coupled to the memory controller by the communication channel; and
re-setting the configuration parameters so that the memory controller recognizes the second memory partition instead of the first memory partition.

23. The process of claim 22 wherein the communication channel comprises first and second communication channels and wherein the first memory partition is coupled to the first communication channel and the second memory partition is coupled to the second communication channel.

24. The process of claim 22 wherein the communication channel comprises first and second communication channels and wherein both the first memory partition and the second memory partition are coupled to the first communication channel and the second communication channel.

25. The process of claim 22 wherein setting configuration parameters in the configuration register so that the memory controller recognizes the first memory partition instead of the second memory partition or the second memory partition instead of the first memory partition comprises setting the configuration parameters to address decode for one partition at a time.

26. The process of claim 22, further comprising coupling one or more additional memory partitions to the communication channel.

27. The process of claim 22, further comprising locking and unlocking the configuration register.

28. The process of claim 27 wherein at least the unlocking is done by a privileged code module having greater memory access privilege than an operating system.

29. The process of claim 28 wherein the privileged code module is the sole means of unlocking the configuration register.

30. The process of claim 28 wherein the privileged code module is an Authenticated Code Module (ACM), a System Management Mode (SMM) module, or an embedded microcontroller.
